(19) United States
(12) Patent Application Publication
(10) Pub. No.: US 2019/0134966 A1
(43) Pub. Date: May 9, 2019

(54) Wall Covering Assembly

(71) Applicant: Amy Greene, Round Lake, IL (US)

(72) Inventor: Amy Greene, Round Lake, IL (US)

(21) Appl. No.: 15/806,459

(22) Filed: Nov. 8, 2017

(51) Int. Cl. B32B 37/00; B65H 16/02; B32B 37/12; B32B 37/06; B44C 7/06

(52) U.S. Cl. CPC B32B 37/0053; B65H 16/028; E04F 13/002; B32B 37/06; B44C 7/06; B32B 37/12

(57) ABSTRACT

A wall covering assembly includes a sheet that is rolled onto itself to form a roll. An adhesive layer is coupled to the sheet and the adhesive layer adheres to a support surface thereby retaining the sheet on the support surface for ornamental purposes. A rolling unit is provided and the roll is rotatably coupled thereto thereby facilitating the sheet to be selectively drawn off of the rolling unit. The rolling unit is manipulated thereby facilitating the sheet to be applied to the support surface. A heating unit is coupled to the rolling unit and the heating unit is in thermal communication with the rolling unit. The heating unit selectively heats the rolling unit when the heating unit is turned on thereby communicating the heat to the adhesive layer for activation.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to covering devices and more particularly pertains to a new covering device for changing an ornamental appearance of a wall without paint and wallpaper.

### BRIEF SUMMARY OF THE INVENTION

An embodiment of the disclosure meets the needs presented above by generally comprising a sheet that is rolled onto itself to form a roll. An adhesive layer is coupled to the sheet and the adhesive layer adheres to a support surface thereby retaining the sheet on the support surface for ornamental purposes. A rolling unit is provided and the roll is rotatably coupled thereto thereby facilitating the sheet to be selectively drawn off of the rolling unit. The rolling unit is manipulated thereby facilitating the sheet to be applied to the support surface. A heating unit is coupled to the rolling unit and the heating unit is in thermal communication with the rolling unit. The heating unit selectively heats the rolling unit when the heating unit is turned on thereby communicating the heat to the adhesive layer for activation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wall covering assembly according to an embodiment of the disclosure.

FIG. 2 is a front perspective in-use view of an embodiment of the disclosure.

FIG. 3 is an exploded front view of an embodiment of the disclosure.

FIG. 4 is a top perspective view of an embodiment of the disclosure.

FIG. 5 is an exploded perspective view of an embodiment of the disclosure.

### DETAILED DESCRIPTION OF THE INVENTION

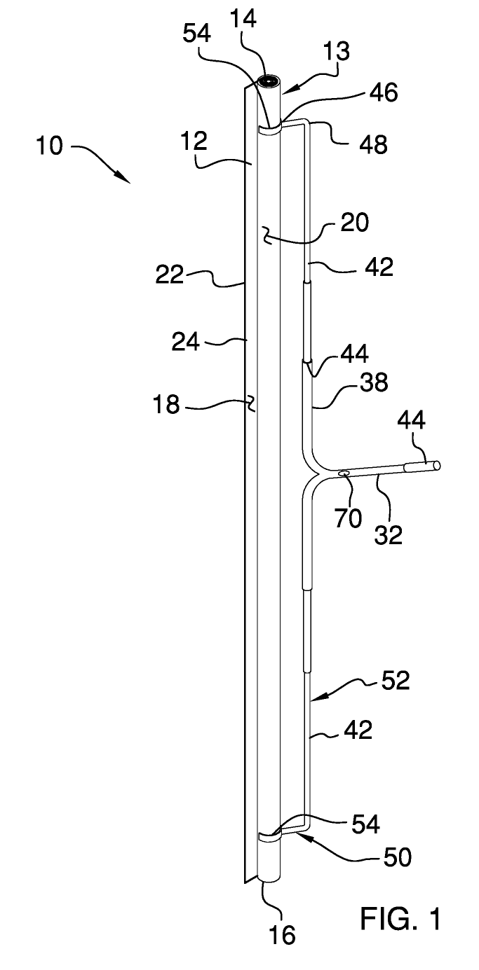

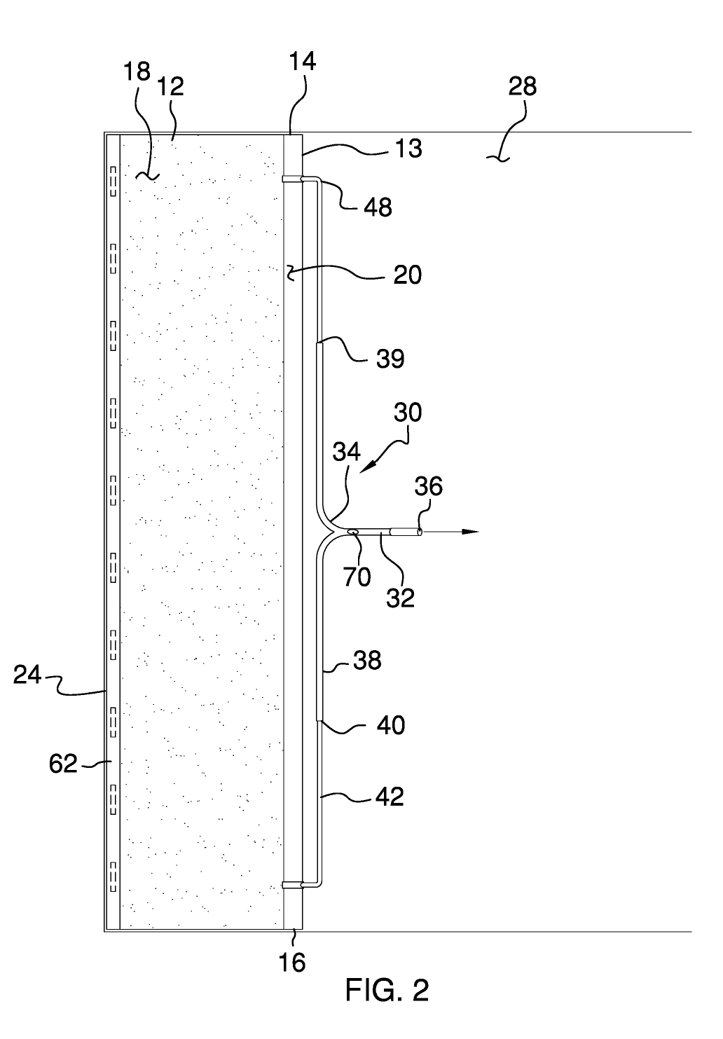

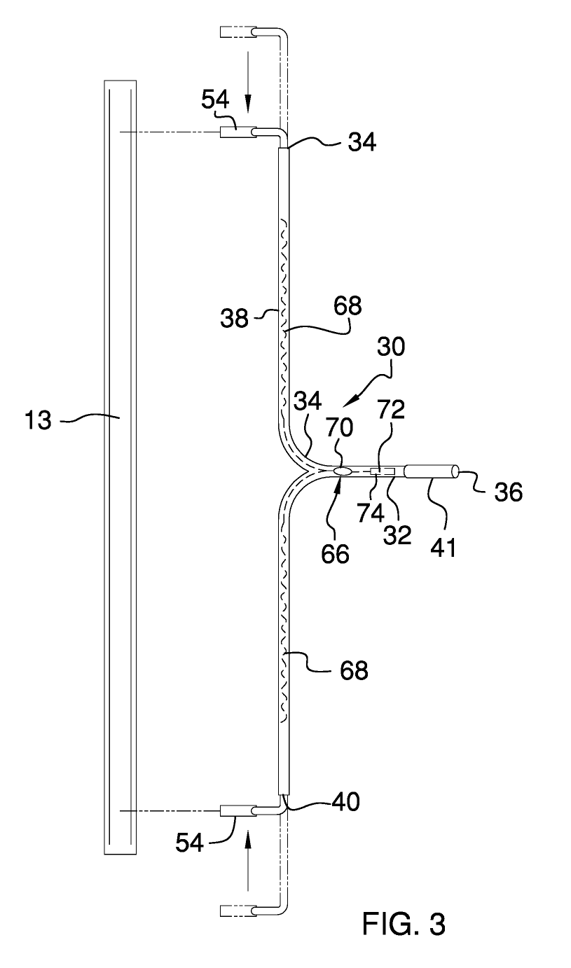

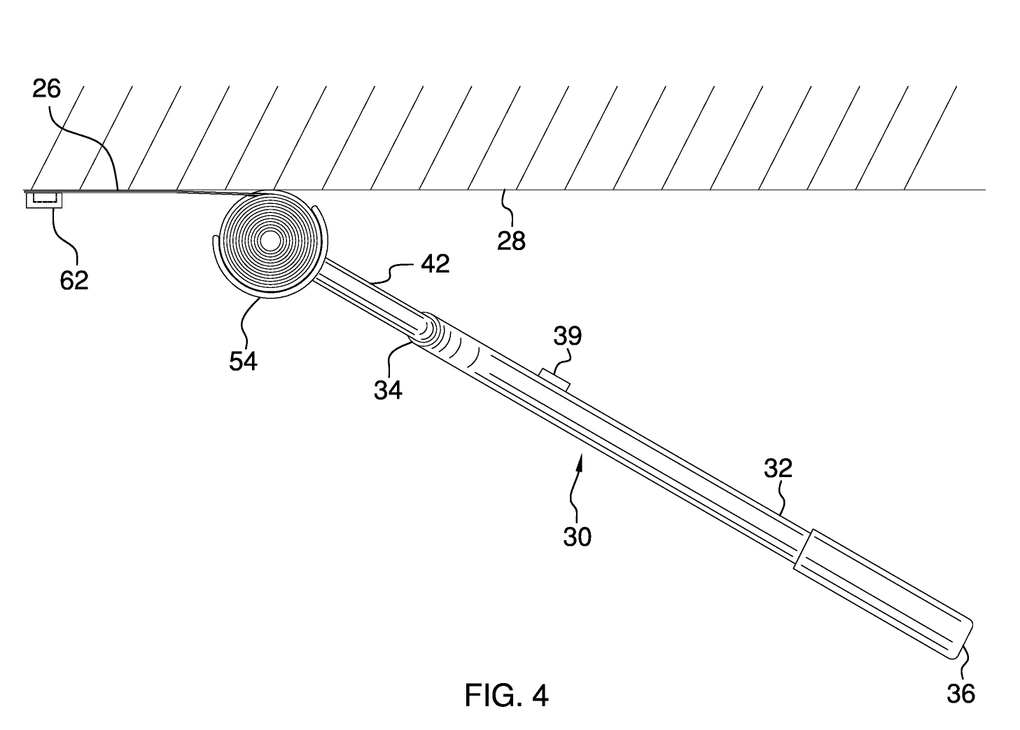

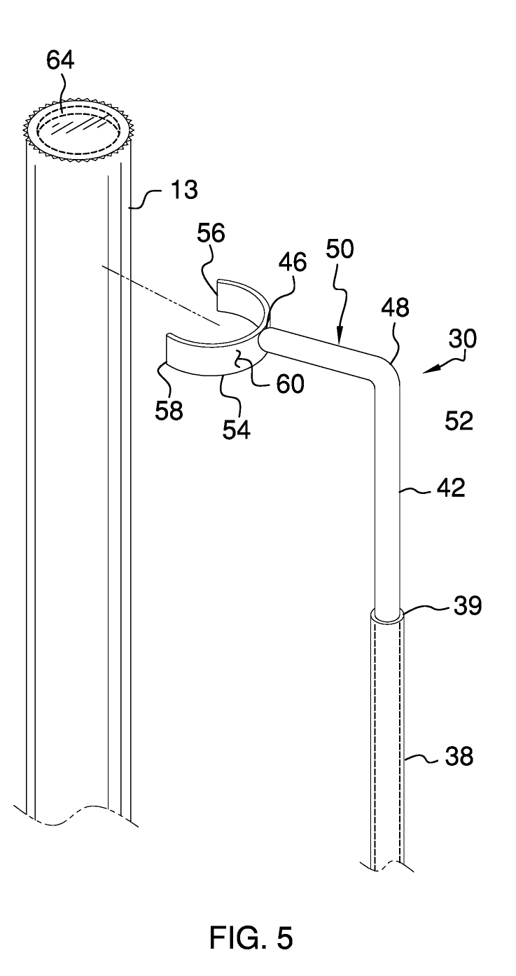

With reference now to the drawings, and in particular to FIGS. 1 through 5 thereof, a new covering device embodying the principles and concepts of an embodiment of the disclosure and generally designated by the reference numeral 10 will be described.

As best illustrated in FIGS. 1 through 5, the wall covering assembly 10 generally comprises a sheet 12 that is rolled onto itself to form a roll 13 that has a first end 14 and a second end 16. The sheet 12 has a first surface 18, a second surface 20 and a peripheral edge 22 extending therebetween. The peripheral edge 22 has a front side 24 and the sheet 12 is selectively drawn off of the roll 13 having the front side 24 being urged away from the roll 13. The sheet 12 is manufactured to have a selected color and pattern on the first surface 18. Additionally, the sheet 12 may be comprised of a fluid impermeable deformable material. The sheet 12 may be manufactured in widths that match common wall heights in residential, commercial and industrial construction.

An adhesive layer 26 is coupled to the second surface 20 of the sheet 12 and the adhesive layer 26 is coextensive with the second surface 20. The adhesive layer 26 selectively adheres to a support surface 28 thereby retaining the sheet 12 on the support surface 28 for ornamental purposes. The support surface 28 may be a wall in a room or the like. The sheet 12 is applied to the wall in lieu of paint, wallpaper and other wall treatments. The adhesive layer 26 may comprise a heat activated adhesive or the like. In this way the adhesive layer 26 resists adhering to the support surface 28 until heat is applied to the adhesive layer 26. Heat may be applied with a hair dryer or other source of heat.

A rolling unit 30 is provided and the roll 13 is rotatably coupled to the rolling unit 30. Moreover, the sheet 12 is selectively drawn off of the rolling unit 30. The rolling unit 30 is manipulated thereby facilitating the sheet 12 to be applied on the support surface 28. In this way the ornamental appearance of the wall is changed without paint, wallpaper and other wall treatments.

The rolling unit 30 comprises a first member 32 that may be gripped and the first member 32 has a first end 34 and a second end 36. A tube 38 is provided that has a first end 39 and a second end 40. The tube 38 is coupled to the first end 34 of the first member 32 having the tube 38 being oriented perpendicular to the first member 32. Additionally, the first member 32 is centrally positioned between the first 39 and second 40 ends of the tube 38. A grip 41 is coupled around the tube 38 for gripping.

The rolling unit 30 includes a pair of second members 42 and each of the second members 42 has a primary end 44 and a secondary end 46. Each of the first 40 and second 42 ends of the tube 38 insertably receives the primary end 44 of an associated one of the second members 42. Additionally, each of the second members 42 has a bend 48 thereon. The bend 48 corresponding to each of the second members 42 is positioned closer to the secondary end 46 than the primary and of the corresponding second member. Moreover, the bend 48 on each of the second members 42 to defines a first portion 50 that is oriented perpendicular to a second portion 52 of the corresponding second member. The first portion 50 corresponding to each of the second members 42 is spaced a selected distance from the tube 38.

The rolling unit 30 includes a pair of grips 54 and each of the grips 54 has a first end 56 and a second end 58. Each of the grips 54 is concavely arcuate between the first and second ends of the grips 54. Thus, the first 56 and second 58 ends corresponding to each of the grips 54 is spaced apart from each other having each of the grips 54 forming an open loop. Each of the grips 54 has an outwardly facing surface 60 and the outwardly facing surface 60 corresponding to each of the grips 54 is coupled to the secondary end 46 of an associated one of the second members 42. Each of the grips 54 is spaced from the first end 14 and the second end 16 of the roll 13 when the roll 13 is positioned in the rolling unit 30. In this way the rolling unit 30 is inhibited from frictionally engaging a ceiling and a floor when the sheet 12 is applied to the support surface 28 thereby facilitating the sheet 12 to be applied to an entire height of the wall.

Each of the grips 54 is comprised of a resiliently bendable material and the first 56 and second 58 ends corresponding to each of the grips 54 are biased toward each other. The roll 13 is selectively urged between the first 56 and second 58 ends of each of the grips 54 such that each of the grips 54 frictionally engages the roll 13. In this way the roll 13 is rotatably retained on the rolling unit 30 having the roll 13 being oriented co-linear with the second members 42. The front side 24 of the roll 13 is selectively urged outwardly between the first 56 and second 58 ends of each of the grips 54. Additionally, each of the grips 54 is comprised of a friction inhibiting material thereby facilitating the roll 13 to rotate in each of the grips 54 when the sheet 12 is drawn outwardly.

A mating member 62 is provided and the mating member 62 is selectively positioned on the sheet 12 when the sheet 12 is positioned on the support surface 28. The mating member 62 releasably engages the support surface 28 thereby facilitating the sheet 12 to be retained on the support surface 28 prior to the sheet 12 being adhered to the support surface 28. Moreover, the mating member 62 is removed from the sheet 12 when the sheet 12 is adhered to the support surface 28. The mating member 62 may include a plurality of magnets for magnetically engaging nails, screws and other metallic structure in the wall.

A pair of cutting tools 64 is provided and each of the cutting tools 64 is removably positioned within the roll 13. Each of the cutting tools 64 is selectively removed from the roll 13 to cut the sheet 12 at selected points. Each of the cutting tools 64 may comprise a spur with teeth for perforating the sheet 12, a knife for cutting the sheet 12 and any other type of mechanical cutter. A heating unit 66 is coupled to the rolling unit 30 and the heating unit 66 is in thermal communication with the rolling unit 30. The heating unit 66 selectively heats the rolling unit 30 when the heating unit 66 is turned on.

The heating unit 66 comprises a heating coil 68 that is coupled to the rolling unit 30 such that the heating coil 68 is in thermal communication with the heating unit 66. A switch 70 is coupled to the rolling unit 30 and the switch 70 is selectively manipulated. The switch 70 is electrically coupled to the heating coil 68 such that the switch 70 turns the heating coil 68 on and off. The rolling unit 30 may communicate the heat from the heating unit 66 to the roll 13 for activating the adhesive. A power supply 72 is coupled to the rolling unit 30 and the power supply 72 is electrically coupled to the heating coil 68. The power supply 72 comprises at least one battery 74.

In use, the roll 13 is urged into each of the grips 54 to rotatably position the roll 13 in the rolling unit 30. The first member 32 is gripped and the rolling unit 30 is manipulated to position the roll 13 on the support surface 28 having the roll 13 being vertically oriented. The front side 24 of the sheet 12 is aligned with a vertical edge of the support surface 28. The mating member 62 is positioned on the sheet 12 and the mating member 62 releasably engages the support surface 28. The rolling unit 30 is urged along the support surface 28 thereby facilitating the sheet 12 to be stretched along the support surface 28. The cutting tools 64 are removed from the roll and are manipulated to cut the sheet 12 around windows, electrical outlets and to cut the sheet 12 to length. Heat is applied to the sheet 12 thereby actuating the adhesive layer 26 to adhere to the support surface 28. In this way the color and appearance of the wall may be modified without the use of paint, wallpaper and other wall treatments.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wall covering assembly being configured to adhere a sheet to a support surface thereby enhancing and changing an ornamental appearance of the support surface, said assembly comprising:
a sheet being rolled onto itself to form a roll;
an adhesive layer being coupled to said sheet, said adhesive layer being configured to adhere to the support surface thereby retaining said sheet on the support surface for ornamental purposes;
a rolling unit having said roll being rotatably coupled thereto thereby facilitating said sheet to be selectively drawn off of said rolling unit said rolling unit comprises
a first member being configured to be gripped, said first member having a first end and a second end,
a tube having a first end and a second end, said tube being coupled to said first end of said first member having said tube being oriented perpendicular to said first member, said first member being centrally positioned between said first and second ends of said tube,
a pair of second members, and
a pair of grips, each of said grips being comprised of a resiliently bendable material, said first and second ends corresponding to each of said grips being biased toward each other, each of said grips engaging said roll such that said roll is positioned parallel to and spaced from said tube; and
a heating unit being coupled to said rolling unit, said heating unit being in thermal communication with said rolling unit, said heating unit selectively heating said tube when said heating unit is turned on.

2. The assembly according to claim 1, wherein said sheet has a first surface, a second surface and a peripheral edge extending therebetween, said peripheral edge having a front side, said sheet being selectively drawn off of said roll having said front side being urged away from said roll, said sheet having a selected color.

3. (canceled)

4. (canceled)

5. The assembly according to claim 1, further comprising each of said second members having a primary end and a secondary end, each of said first and second ends of said tube insertably receiving said primary end of an associated one of said second members.

6. The assembly according to claim 5, wherein each of said second members has a bend thereon, said bend corresponding to each of said second members being positioned closer to said secondary end than said primary end of said corresponding second member to define a first portion being oriented perpendicular to a second portion of said corresponding second member, said first portion corresponding to each of said second members being spaced a selected distance from said tube.

7. The assembly according to claim 6, further comprising each of said grips having a first end and a second end, each of said grips being concavely arcuate between said first and second ends of said grips such that said first and second ends corresponding to each of said grips is spaced apart from each other having each of said grips forming an open loop, each of said grips having an outwardly facing surface, said outwardly facing surface corresponding to each of said grips being coupled to said secondary end of an associated one of said second members.

8. (canceled)

9. The assembly according to claim 7, wherein said roll is selectively urged between said first and second ends of each of said grips such that each of said grips frictionally engages said roll to retain said roll on said rolling unit having said roll being oriented co-linear with said second members, said front side of said sheet being selectively urged outwardly between said first and second ends of each of said grips.

10. The assembly according to claim 1, further comprising a mating member being configured to be manipulated, said mating member being positioned on said sheet when said sheet is positioned on the support surface, said mating member being configured to releasably engage the support surface thereby facilitating said sheet to be retained on the support surface prior to being adhered to the support surface, said mating member being removed from said sheet when said sheet is adhered to the support surface.

11. The assembly according to claim 1, further comprising a pair of cutting tools, each of said cutting tools being removably positioned within said roll wherein each of said cutting tools is configured to be manipulated, each of said cutting tools selectively cutting said sheet at selected points.

12. The assembly according to claim 1, wherein said heating unit comprises a heating coil being coupled to said rolling unit such that said heating coil is in thermal communication with said heating unit.

13. The assembly according to claim 12, further comprising a switch being coupled to said rolling unit wherein said switch is configured to be manipulated, said switch being electrically coupled to said heating coil such that said switch turns said heating coil on and off.

14. The assembly according to claim 13, further comprising a power supply being coupled to said rolling unit, said power supply being electrically coupled to said heating coil, said power supply comprising at least one battery.

15. A wall covering assembly being configured to adhere a sheet to a support surface thereby enhancing and changing an ornamental appearance of the support surface, said assembly comprising:
a sheet being rolled onto itself to form a roll having a first end and a second end, said sheet having a first surface, a second surface and a peripheral edge extending therebetween, said peripheral edge having a front side, said sheet being selectively drawn off of said roll having said front side being urged away from said roll, said sheet having a selected color;
an adhesive layer being coupled to said second surface of said sheet, said adhesive layer being coextensive with said second surface, said adhesive layer being configured to adhere to the support surface thereby retaining said sheet on the support surface for ornamental purposes;
a rolling unit having said roll being rotatably coupled thereto thereby facilitating said sheet to be selectively drawn off of said rolling unit, said rolling unit comprising:
a first member being configured to be gripped, said first member having a first end and a second end,
a tube having a first end and a second end, said to being coupled to said first end of said first member having said tube being oriented perpendicular to said first member, said first member being centrally positioned between said first and second ends of said tube,
a pair of second members, each of said second members having a primary end and a secondary end, each of said first and then said second end of said tube insertably receiving said primary end of an associated one of said second members, each of said second members having a bend thereon, said bend corresponding to each of said second members being positioned closer to said secondary end than said primary end of said corresponding second member to define a first portion being oriented perpendicular to a second portion of said corresponding second member, said first portion corresponding to each of said second members being spaced a selected distance from said tube, and
a pair of grips, each of said grips having a first end and a second end, each of said grips being concavely arcuate between said first and second ends of said grips such that said first and second ends corresponding to each of said grips is spaced apart from each other having each of said grips forming an open loop, each of said grips having an outwardly facing surface, said outwardly facing surface corresponding to each of said grips being coupled to said secondary end of an associated one of said second members, each of said grips being comprised of a resiliently bendable material, said first and second ends corresponding to each of said grips being biased toward each other, said roll being selectively urged between said first and second ends of each of said grips such that each of said grips frictionally engages said roll to retain said roll on said rolling unit having said roll being oriented co-linear with said second members, said front side of said roll being selectively urged outwardly between said first and second ends of each of said grips;
a mating member being configured to be manipulated, said mating member being positioned on said sheet when said sheet is positioned on the support surface, said mating member being configured to releasably engage the support surface thereby facilitating said sheet to be retained on the support surface prior to being adhered to the support surface, said mating member being removed from said sheet when said sheet is adhered to the support surface;
a pair of cutting tools, each of said cutting tools being removably positioned within said roll wherein each of said cutting tools is configured to be manipulated, each of said cutting tools selectively cutting said sheet at selected points; and
a heating unit being coupled to said rolling unit, said heating unit being in thermal communication with said rolling unit, said heating unit selectively heating said tube when said heating unit is turned on, said heating unit comprising;
a heating coil being coupled to said rolling unit such that said heating coil is in thermal communication with said heating unit,
a switch being coupled to said rolling unit wherein said switch is configured to be manipulated, said switch being electrically coupled to said heating coil such that said switch turns said heating coil on and off, and
a power supply being coupled to said rolling unit, said power supply being electrically coupled to said heating coil, said power supply comprising at least one battery.
